(19) United States
(12) Patent Application Publication
(10) Pub. No.: US 2014/0301294 A1
(43) Pub. Date: Oct. 9, 2014

(54) METHOD FOR DIRECT COMMUNICATION BETWEEN STATIONS IN WIRELESS LOCAL AREA SYSTEM

(71) Applicant: Electronics and Telecommunications Research Institute, Daejeon (KR)

(72) Inventors: Hyoung Jin KWON, Daejeon (KR); Jae Seung LEE, Daejeon (KR); Min Ho CHEONG, Daejeon (KR); Sok Kyu LEE, Daejeon (KR); Hee Jung YU, Daejeon (KR)

(73) Assignee: Electronics and Telecommunications Research Institute, Daejeon (KR)

(21) Appl. No.: 14/227,893

(22) Filed: Mar. 27, 2014

(30) Foreign Application Priority Data
Mar. 28, 2013 (KR) 10-2013-0033803
Mar. 27, 2014 (KR) 10-2014-0035949

(51) Int. Cl. H04W 76/02; H04W 72/04

(52) U.S. Cl. CPC H04W 76/023; H04W 72/0453
USPC 370/329

(57) ABSTRACT

Disclosed is a method for direct communication between stations. The method for direct communication between stations may include: receiving scheduling information on a frequency selective transmission (FST) from an access point; setting up a link for communication with another station based on the scheduling information; and communicating with the other station using the link.

### TECHNICAL FIELD

The following description relates to a method for direct communication between stations in a wireless local area network (WLAN) system and a scheduling method.

### RELATED ART

A near field communication network, for example, a local area network (LAN) is generally classified into a wired LAN and a wireless LAN (WLAN). In the WLAN, communication may be performed on a network using radio wave instead of using cable. The WLAN has been proposed as an alternative for outperforming difficulties in maintenance and repair, movement, and installation of cabling. Due to an increase in mobile device users, the need for the WLAN is also increasing.

The WLAN may include an access point (AP) and a station (STA). The AP refers to equipment configured to transmit radio wave so that WLAN users present within a transmission distance may use an Internet access and a network. The AP may function as a base station of a mobile phone or a hub of a wired network. In a high speed wireless Internet service provided from an Internet service provider (ISP), equipment such as an AP is already installed in a service area.

A basic configuration block of an Institute of Electrical and Electronic Engineers (IEEE) 802.11 network may include a basic service set (BSS). The IEEE 802.11 network may include an independent network, for example, an independent BSS in which STAs within a BSS mutually perform direct communication, an infrastructure network, for example, an infrastructure BSS in which an AP is involved while an STA communicates with another STA present within or outside a BSS, and an extended service set in which service coverage is extended by connecting a BSS and another BSS.

### DESCRIPTION OF INVENTION

### Solutions

According to an embodiment, there is provided a method for direct communication between stations, the method including: receiving scheduling information on a use of a subchannel from an access point; setting up a link for communication with another station based on the scheduling information; and communicating with the other station using the link.

The setting up may include: identifying at least one subchannel unused for a frequency selective transmission based on the scheduling information; and determining a subchannel for communication with the other station among the at least one subchannel.

The setting up may include: setting priorities of subchannels unused for the frequency selective transmission based on the scheduling information; and determining a subchannel to be used for communication with the other station based on the set priorities.

The setting up may include: receiving information on a subchannel used for the frequency selective transmission from the access point; and setting, as the link for communication with the other station, a subchannel orthogonal to the subchannel used for the frequency selective transmission.

The scheduling information may include period information of a frequency selective transmission performed by the access point.

According to another embodiment, there is provided a method for direct communication between stations, the method including: receiving scheduling information on a frequency selective transmission from an access point; determining a tunneled direct link setup (TDLS) schedule for communication with another station based on the scheduling information on the frequency selective transmission; and performing a TDLS with the other station based on the determined TDLS schedule.

According to still another embodiment, there is provided a station, including: a communicator configured to receive scheduling information on a use of a subchannel from an access point; and a link setter configured to set up a link for communication with another station based on the scheduling information. The communicator may communicate with the other station using the link.

According to still another embodiment, there is provided a station, including: a link setter configured to request an access point for information on a frequency selective transmission or restricted access window parameter set (RPS) information using a probe request frame; and a communicator configured to receive information on the frequency selective transmission or the RPS information from the access point in response to the request. The link setter may set up a link for communication with the other station based on information on the frequency selective transmission or the RPS information.

### BRIEF DESCRIPTION OF DRAWINGS

FIG. 1 illustrates a wireless local area network (WLAN) system according to an embodiment.

FIG. 2 is a block diagram illustrating a configuration of a station according to an embodiment.

FIG. 3 illustrates a format of a FST information element (IE) according to an embodiment.

FIG. 4 illustrates an example of setting a tunneled direct link setup (TDLS) schedule according to an embodiment.

FIG. 5 is a flowchart illustrating a method for direct communication between stations according to an embodiment.

### DETAILED DESCRIPTION

Hereinafter, embodiments of the present invention will be described with reference to the accompanying drawings. The detailed description to be disclosed in the following with the accompanying drawings is provided to describe the embodiments and is not to describe a sole embodiment capable of implementing the present invention. The following description may include specific details to provide the full understanding of the present invention. However, it will be apparent to a person of ordinary skill that the present invention may be carried out even without the specific details.

The following embodiments may be provided in a form in which constituent elements and features of the present invention are combined. Each constituent element or feature may be construed to be selective unless explicitly defined. Each constituent element or feature may be implemented without being combined with another constituent element or feature. Also, the embodiments may be configured by combining a portion of constituent elements and/or features. Orders of operations described in the embodiments may be changed. A partial configuration or feature of a predetermined embodiment may be included in another embodiment, and may also be changed with a configuration or a feature corresponding to the other embodiment.

Predetermined terminologies used in the following description are provided to help the understanding of the present invention and thus, use of predetermined terminology may be changed with another form without departing from the technical spirit of the present invention.

In some cases, a known structure and device may be omitted or may be provided as a block diagram based on a key function of each structure and device in order to prevent the concept of the present invention from being ambiguous. In addition, like reference numerals refer to like constituent elements throughout the present specification.

The embodiments may be supported by standard documents disclosed in at least one of wireless access systems, for example, an Institute of Electrical and Electronic Engineers (IEEE) 802 system, a Third Generation Partnership Project (3GPP) system, a 3GPP Long Term Evolution (LTE) and LTE-Advanced (LTE-A) system, and a 3GPP2 system. That is, operations or portions not described to clearly disclose the technical spirit of the present invention among the embodiments may be supported by the standard documents. Further, all the terminologies used herein may be explained by the standard documents.

The following technology may be employed for a variety of wireless access systems, for example, a code division multiple access (CDMA), a frequency division multiple access (FDMA), a time division multiple access (TDMA), an orthogonal frequency division multiple access (OFDMA), and a single carrier frequency division multiple access (SC-FDMA). The CDMA may be embodied using a wireless technology such as a universal terrestrial radio access (UTRA) or CDMA 2000. The TDMA may be embodied using a wireless technology such as a global system for mobile communications (GSM)/general packet radio service (GPRS)/enhanced data rates for GSM evolution (EDGE). The OFDMA may be embodied using a wireless technology such as IEEE 802.11 (Wi-Fi), IEEE 802.16 (WiMAX), IEEE 802-20, and evolved UTRA (E-UTRA). For clarity and conciseness, description is made generally based on an IEEE 802.11 system, however, the technical spirit of the present invention is not limited thereto or restricted thereby.

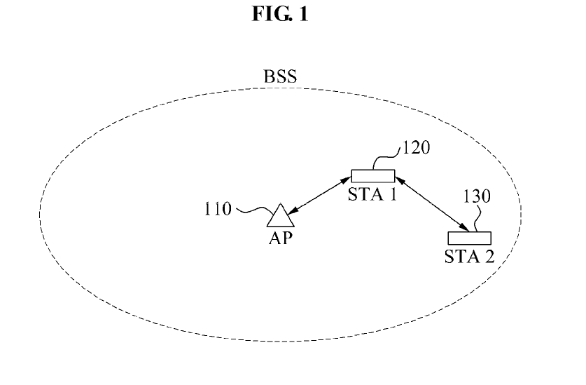

FIG. 1 illustrates a wireless local area network (WLAN) system according to an embodiment.

Referring to FIG. 1, the WLAN system may include an access point (AP) 110 and a station (STA) configured to communicate with the AP 110 within a basic service set (BSS) of the AP 110. The STA may communicate with another STA as well as the AP 110.

According to an embodiment, the AP 110 may perform a frequency selective transmission (FST) that uses a narrowband subchannel in a wideband BSS. The FST may also be referred to as a subchannel selective transmission (SST). The AP 110 may select a frequency band optimal for an STA in which power saving is construed being important, and may communicate with the STA using the selected frequency band. The STA may select a subchannel most appropriate for the STA from among a plurality of subchannels allowed by the AP 110. When performing the FST, the AP 110 may change a using subchannel based on a predetermined schedule. Other subchannels excluding the subchannel used by the AP 110 are empty and thus, the STA may directly communicate with another STA through an empty subchannel.

An STA 1 120 may directly communicate with an STA 2 130 without using the AP 110. For example, the STA 1 120 may directly communicate with the STA 2 130 using a tunneled direct link setup (TDLS) method. When the STA 1 120 directly communicates with the STA 2 130, the STA 1 120 may directly exchange data with the STA 2 130 without relay of the AP 110.

The STA 1 120 may directly communicate with the STA 2 130 using another subchannel that does not overlap a subchannel used by the AP 110 for the FST. For example, the STA 1 120 may perform a TDLS using a subchannel unused by the AP 110, thereby restraining interference and competition for channel access and enhancing a throughput and power saving performance of the entire network. A TDLS method may encapsulate a management action frame, such as a direct link setup (DLS) request, a DLS response, and a direct link (DL) teardown, to be a data frame and may transmit the data frame.

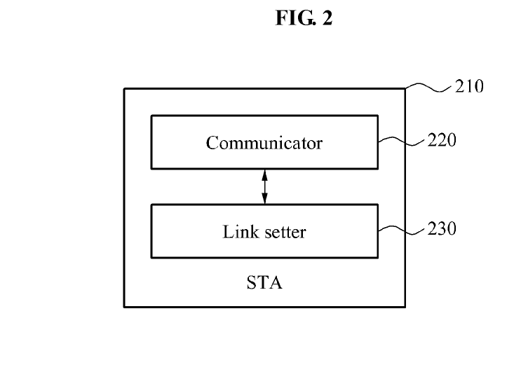

FIG. 2 is a block diagram illustrating a configuration of an STA 210 according to an embodiment.

The STA 210 may directly communicate with another STA through a subchannel unused by an AP for an FST. According to an embodiment, the STA 210 may set a TDLS schedule based on an FST schedule set by the AP. The STA 210 may decrease interference by setting a schedule, possibly, not to overlap the predetermined FST schedule of the AP. The STA 210 may effectively use resources without causing interference by using a frequency different from a frequency of a subchannel used for communication between the AP and the STA 210.

Referring to FIG. 2, the STA 210 may include a communicator 220 and a link setter 230.

The communicator 220 may receive scheduling information on the FST from the AP. The scheduling information on the FST may include information on a subchannel used for the FST. Alternatively, when the FST has a periodic feature, the scheduling information on the FST may include period information of the FST.

The link setter 230 may set up a link for communication with another STA based on the scheduling information received from the AP. The link setter 230 may identify at least one subchannel unused for the FST based on the scheduling information on the FST. For example, the link setter 230 may identify a subchannel used by the AP for an FST using an FST information element (IE) within a beacon received from the AP.

The link setter 230 may determine a subchannel for communication with the other station among the at least one subchannel unused for the FST. The link setter 230 may determine subchannels available for a TDLS based on the subchannel used for the FST. For example, the link setter 230 may set, as a link for communication with another station, a subchannel orthogonal to a subchannel used for an FST.

A TDLS between stations may be performed through the subchannel determined by the link setter 230. Accordingly, AP-STA data exchange and TDLS data exchange may be simultaneously performed. Two STAs that are to perform a TDLS may negotiate with each other about a subchannel to be used for the TDLS. The link setter 230 may generate a list of subchannels available for communication with the other STA and may share the list of available subchannels with the other STA. The link setter 230 may determine a subchannel to be used for communication with the other STA through negotiation with the other STA. For example, two STAs may exchange a list of available subchannels based on a unit of 2 MHz and may determine subchannels to be used through negotiation. In this example, the link setter 230 may determine a subchannel for communication with another STA based on effect of interference.

The link setter 230 may set a subchannel least affected by interference among the at least one subchannel, as the link for communication with the other station. As another example, the link setter 230 may set priorities of subchannels unused for an FST based on scheduling information received from the AP. The link setter 230 may determine a subchannel to be used for communication with another station based on the set priorities. In detail, the link setter 230 may set, as the link for communication with the other station, a subchannel having a top priority among subchannels excluding a subchannel used for the FST. Two STAs may exclude, from the list, a subchannel including interference caused by an overlapping BSS (OBSS). Alternatively, the link setter 230 may include, in the list, a subchannel including interference caused by the OBSS and in this instance, may assign a relatively low priority to the subchannel. The link setter 230 may set a priority of a subchannel including interference to be relatively low in the list.

The communicator 220 may communicate with the other STA using the link set up by the link setter 230.

Two STAs operating in an TDLS peer power saving mode (PSM) may exchange a preference list and make a negotiation when setting up a TDLS and exchanging a TDLS peer PSM request/response frame. A list of subchannels available between the two STAs may be determined through the negotiation. The determined list of available subchannels may include the available subchannels and priority information of each subchannel.

When the TDLS is set up, the AP may broadcast a dynamically varying use channel of the FST through a beacon. When the TDLS is set up, the communicator 220 may receive the beacon from the AP. A TDLS peer STA may set a wakeup schedule based on a target beacon transmission time (TBTT) of the beacon when exchanging a TDLS peer PSM request/response frame to set a TDLS peer PSM. When the wakeup schedule is not aligned in the TBTT, the communicator 220 may wake up in a just previous TBTT of the wakeup schedule and may receive the beacon. A TDLS peer unscheduled automatic power save delivery (U-APSD) (TPU) buffer/sleep STA having set a TDLS peer U-APSD mode may receive the beacon.

The TDLS peer STA may search for an available subchannel of the TDLS orthogonal to a subchannel used for the FST, which is allowed by the AP during a beacon period, through an FST IE included in the beacon. When a plurality of subchannels is available for the TDLS, the TDLS peer STA may move to a subchannel having a top priority based on priorities of subchannels determined when setting up the TDLS. When the TDLS peer STA moves to the subchannel having the top priority, data transmission may be initiated after an active start time of the FST IE. When a list of subchannels available for the TDLS is not predetermined, or when using a predetermined subchannel irrespective of predetermined order of the list, the TDLS peer STA may explicitly notify an STA performing the TDLS with the TDLS peer STA, for example, the STA 210 about a subchannel to be used for the TDLS by exchanging a frame. Here, the TDLS peer STA may notify the STA 210 about the subchannel to be used using a channel switch request/response frame.

When the STA 210 performs an FST with the AP and performs an TDLS with another STA, the STA 210 may sequentially use subchannels. For example, the STA 210 may initially complete data exchange with the AP through the FST and then may exchange data with the TDLS peer STA. In this example, the STA 210 may notify the TDLS peer STA about the absence of the STA 210 in order to save power of the TDLS peer STA awaiting in a subchannel orthogonal to a subchannel used for the FST. For example, the STA 210 may notify the TDLS peer STA about an absolute value or a relative value. Here, the absolute value indicates a restoration time at which the STA 210 is restored from the FST performed with the AP to an original state in order to perform a TDLS with another STA, that is, a time at which the FST is completed. The relative value indicates a remaining time from a predetermined time, for example, a reference time to the restoration time. The reference time may be, for example, a wakeup schedule start time promised between the STA 210 and the TDLS peer STA. Accordingly, an amount of power consumed by the TDLS peer STA that is a counter party of the STA 210 may be reduced.

According to another embodiment, an FST schedule may be predetermined. When the FST schedule is periodically allocated, an amount of power consumed by the STA 210 may be reduced. When an FST is performed based on a predetermined period, scheduling information on the FST may include period information of the FST. For example, information associated with a period of the FST may be included in an FST IE. Alternatively, period information of the FST may be signaled in a form of a periodic restricted access window (PRAW). A time section allocated for the FST in a predetermined subchannel may be signaled through the PRAW.

The communicator 220 may receive scheduling information on the FST from the AP. When a schedule of the FST performed by the AP is periodic, the link setter 230 may determine a periodic schedule for communication with another STA based on the schedule of the FST. The link setter 230 may select a schedule to be used for direct communication with the other STA from among determined at least one schedule through negotiation with the other STA. For example, the link setter 230 may negotiate with the other STA about a schedule to be used for direction communication with the other STA, based on at least one of channel information, a power saving period of the STA 210, and a size of data to be transmitted by the STA 210. The communicator 220 may directly communicate with the other STA based on the selected schedule.

The AP may notify a periodically determined FST schedule through an FST IE or a PRAW. The link setter 230 may determine at least one schedule about a subchannel to be used for communication with another STA. The link setter 230 may determine a TDLS schedule for communication with the other STA based on scheduling information on the FST received from the AP. The link setter 230 may set the TDLS schedule based on the periodically determined FST schedule. The link setter 230 may identify a subchannel used for the FST from the FST schedule, and may set the TDLS schedule based on a subchannel orthogonal to the identified subchannel. An STA having set up a TDLS may exclude a use of a subchannel used in the FST schedule of the AP. The TDLS schedule based on the FST schedule of the AP may also have a periodic form. A subchannel included in the TDLS schedule may include a subchannel unused in the FST schedule.

When a plurality of TDLS schedules is determined, the link setter 230 may negotiate with another STA about a TDLS schedule and may determine a final TDLS schedule based on at least one of a power saving period and a size of data to be transmitted. The communicator 220 may perform a TDLS with the other STA based on the determined TDLS schedule. A wakeup schedule needs to be determined to determine the TDLS schedule and thus, the TDLS schedule may be determined by an STA that is to operate in a TDLS peer PSM mode. The TDLS schedule based on an FST schedule of the AP may be confirmed after exchanging a wakeup schedule as well as a TDLS peer PSM request/response frame.

According to another embodiment, when an AP moves from a current unit primary channel, for example, ½ MHz in the case of 802.11ah and 20 MHz in the case of 802.11ac, to another subchannel in order to perform an SST, the AP may transmit, to an STA, information on a subchannel to move to through a restricted access window parameter set (RPS) element. For example, information on the subchannel to move to may be stored in a channel (CH) indication field of the RPS element. A non-SST STA that is an STA not supporting an SST may estimate a subchannel to be used for the SST based on the RPS element included in a beacon. When the non-SST STA determines that a unit primary channel is not included in a CH indication field of an RPS element, the non-SST STA may not perform a channel access for exchanging data with the AP through a corresponding primary channel during a RAW period. However, the non-SST STA may perform a channel access with an STA having set up a TDLS through a primary channel. When the STA 210 is a non-SST STA, the link setter 230 may estimate a subchannel used for the SST or the FST based on the RPS element received from the AP. The RPS element may be included in a beacon transmitted from the AP. The link setter 230 may determine a subchannel for communication with another STA among subchannels excluding the estimated subchannel. The link setter 230 may perform the TDLS with the other STA based on the determined subchannel.

An example of performing a TDLS in a case in which the STA 210 supports an SST and another STA is a non-SST STA that does not support SST will be described. The STA 210 supporting the SST may explicitly transmit information on a subchannel to be used for a TDLS to the non-SST STA. The communicator 220 may receive scheduling information on the SST from the AP, and may determine a subchannel to be used for the TDLS based on the scheduling information. For example, the link setter 230 may determine a subchannel least affected by interference, as the subchannel to be used for the TDLS among subchannels unused for the SST. The link setter 230 may store information on the subchannel to be used for the TDLS in a channel switch request frame. The communicator 220 may transmit the channel switch request frame to the non-SST STA. The non-SST STA may obtain information on the subchannel to be used for the TDLS from the channel switch request frame, and may perform the TDLS with the STA 210 based on information on the corresponding subchannel.

An example of performing a TDLS in a case in which the STA 210 is a non-traffic indication map (TIM) STA that does not listen to a beacon, and operates in a target wake time (TWT) will be described. A TWT element transmitted between an AP and an STA may include a CH indication field. The AP may indicate a plurality of subchannels as a bitmap in the CH indication field of the TWT element. The link setter 230 may request the AP for information on an FST or an SST or RPS information using a probe request frame. In response to the request, the communicator 220 may receive information on the FST or RPS information from the AP. SST information may include information on a subchannel used for the SST and scheduling information of the SST including a point in time in which a transmission is allowed. RPS information may include information on the subchannel used for the SST, and information on a RAW that is set based on a duration in which a transmission is allowed and a start time of another SST schedule. Scheduling information of the SST may be converted and thereby included in the RPS information. The link setter 230 may set up a link for communication with another STA based on information on the FST or the RPS information. The link setter 230 may determine a subchannel to be used for a TDLS based on SST information or RPS information. For example, the link setter 230 may identify a subchannel used for an SST based on SST information or RPS information, and may determine a subchannel having relatively less collision or interference as a subchannel to be used for a TDLS among subchannels excluding the identified subchannel. Although the AP allows an SST operation in a plurality of subchannels, a TWT STA may select a single subchannel from among the allowed subchannels and may use the selected subchannel. Accordingly, in a RAW allocated for the TWT STA, the link setter 230 may dynamically determine a subchannel used for a TWT operation in order to perform a channel access and may perform a dynamic subchannel determining method for determining a subchannel to be used for a TDLS based on the determination result. When a TWT operating as a plurality of SSTs of a single BSS within a single RAW is allocated, a subchannel used for communication with the AP may vary based on a channel state of the TWT STA. Due to a dynamic phenomenon that a subchannel to be used does not appear in an RPS, an STA may need to determine the subchannel by listening to a channel. When the subchannel to be used for the TDLS is determined, the link setter 230 may store information on the determined subchannel in a channel switch request frame, and the communicator 220 may transmit the channel switch request frame to the non-SST STA. A TDLS peer STA may obtain information on the subchannel to be used for the TDLS from the channel switch request frame, and may perform the TDLS with the STA 210 based on the corresponding subchannel.

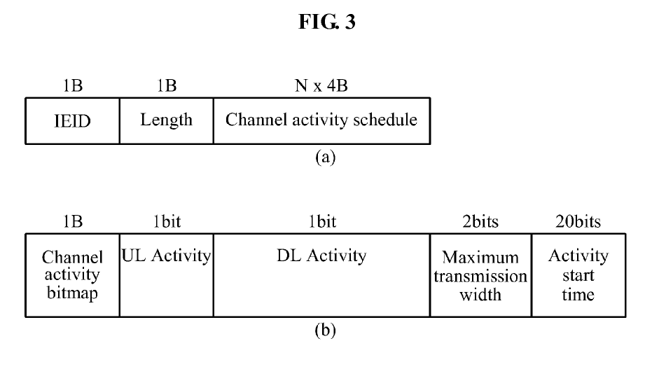

FIG. 3 illustrates a format of an FST IE according to an embodiment.

An AP may broadcast a list of channels available for an FST through a beacon. Information on the FST may be included in an FST IE of the beacon. A format of the FST IE may be expressed as illustrated in (a) of FIG. 3. Channels having the same schedule are indicated in a form of a channel activity bitmap in a single FST IE and thus, at least one value needs to be set to “1”. A format of a subfield of a channel activity schedule included in the FST IE may be expressed as illustrated in (b) of FIG. 3.

An STA may identify subchannels allowed by the AP from the FST IE of the beacon received from the AP. The AP may perform a subsequent FST from an activity start time in a subchannel to be used.

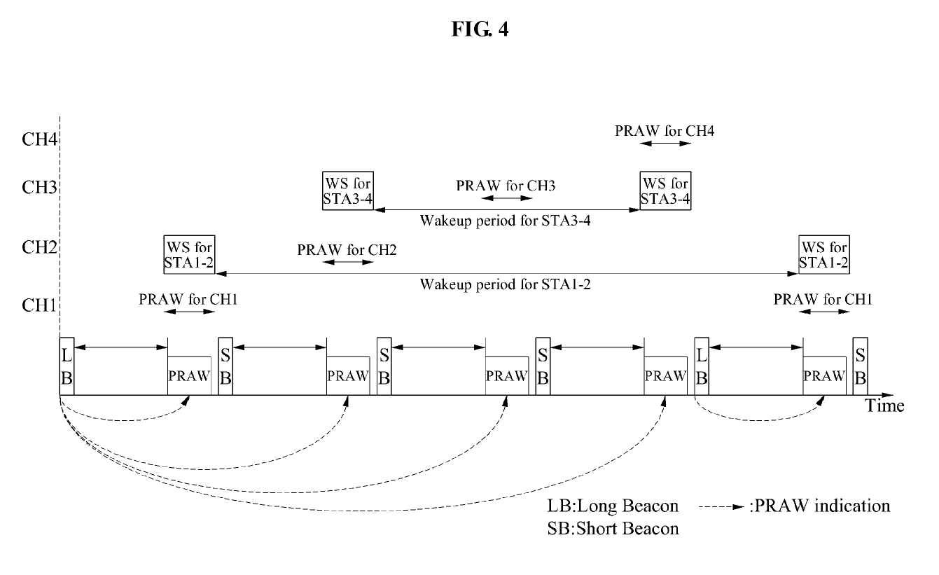

FIG. 4 illustrates an example of setting a TDLS schedule according to an embodiment.

In detail, FIG. 4 illustrates an example of setting a periodic TDLS schedule based on a periodic FST schedule in a TDLS peer PSM. An STA may determine an optimal TDLS schedule based on channel information and a traffic schedule of the STA, while not overlapping an FST schedule of an AP.

In FIG. 4, it is assumed that the AP notifies a periodic FST schedule through a PRAW. The STA may determine a wakeup schedule for a TDLS peer STA and the STA based on PRAW information and a maximum transmission width and an activity start time included in an FST IE. A wakeup schedule for an STA 1 and an STA 2 and a wakeup schedule for an STA 3 and an STA 4 of FIG. 4 are examples and a constraint condition is that a wakeup schedule does not overlap a frequency and a time of an FST performed by the AP.

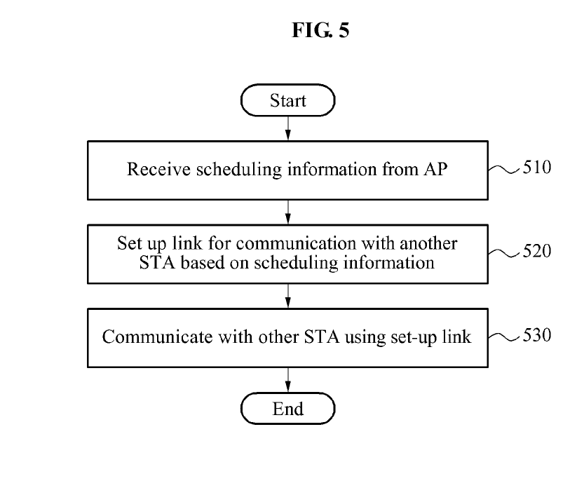

FIG. 5 is a flowchart illustrating a method for direct communication between stations according to an embodiment.

In operation 510, an STA may receive scheduling information on an FST from an AP. Scheduling information on the FST may include information on a subchannel used for the FST. Alternatively, when the FST has a periodic feature, the scheduling information on the FST may include period information of the FST.

In operation 520, the STA may set up a link for communication with another STA based on the scheduling information received from the AP. The STA may identify at least one subchannel unused for the FST based on the scheduling information on the FST.

The STA may determine the subchannel for communication with the other STA among at least one subchannel unused for the FST. The STA may identify the at least one subchannel unused for the FST based on the scheduling information. The STA may determine the subchannel for communication with the other STA among the identified at least one subchannel. For example, the STA may set, as a link for communication with the other STA, a subchannel orthogonal to the subchannel used for the FST. Alternatively, the STA may set a subchannel least affected by interference among the at least one subchannel, as the link for communication with the other STA.

The STA may generate a list of subchannels available for communication with the other STA and may share the generated list with the other STA. The STA may determine a subchannel to be used for communication with the other STA through negotiation with the other STA.

The STA may set priorities of subchannels unused for the FST based on scheduling information received from the AP. For example, the STA may set priorities of subchannels based on effect of interference in each subchannel. The STA may determine the subchannel to be used for communication with the other STA based on the set priorities. For example, the STA may set, as a link for communication with another station, a subchannel having a top priority among subchannels excluding a subchannel used for the FST.

According to another embodiment, an FST schedule may be predetermined. When an FST is performed based on a predetermined period, scheduling information on the FST may include period information of the FST performed by the AP. For example, period information of the FST may be signaled in a form of a PRAW, or may be included in an FST IE and thereby be transmitted. The STA may determine a TDLS schedule for communication with another STA based on scheduling information on the FST. In detail, the STA may determine the TDLS schedule based on an FST schedule received from the AP. The TDLS schedule may be determined through negotiation with the other STA. The STA may determine at least one schedule about a subchannel to be used for communication with the other STA based on period information of the FST. The STA may select a schedule to be used for communication from among the determined at least one schedule through negotiation with the other STA. Also, the STA may negotiate with the other STA about a wakeup schedule. The STA may negotiate with the other STA about the schedule based on at least one of channel information, a power saving period of the STA, and a size of data to be transmitted.

In operation 530, the STA may communicate with the other STA using the set-up link. For example, the STA may perform a TDLS with the other STA based on a TDLS schedule determined through a negotiation process with the other STA. Accordingly, AP-STA data exchange and TDLS data exchange may be simultaneously performed.

The above-described embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### EXPLANATIONS OF NOTATIONS

210: station
220: communicator
230: link setter

What is claimed is:

1. A method for direct communication between stations performed by a station, the method comprising:
receiving scheduling information on a frequency selective transmission from an access point;
setting up a link for communication with another station based on the scheduling information; and
communicating with the other station using the link.

2. The method of claim 1, wherein the setting up comprises:
identifying at least one subchannel unused for the frequency selective transmission based on the scheduling information; and
determining a subchannel for communication with the other station among the at least one subchannel.

3. The method of claim 2, wherein the determining comprises setting a subchannel least affected by interference among the at least one subchannel, as the link for communication with the other station.

4. The method of claim 1, wherein the setting up comprises:
setting priorities of subchannels unused for the frequency selective transmission based on the scheduling information; and
determining a subchannel to be used for communication with the other station based on the set priorities.

5. The method of claim 1, wherein the setting up comprises:
sharing a list of subchannels available for communication with the other station with the other station; and
determining a subchannel to be used for communication with the other station through negotiation with the other station.

6. The method of claim 1, wherein the setting up comprises setting, as the link for communication with the other station, a subchannel orthogonal to a subchannel used for the frequency selective transmission.

7. The method of claim 1, wherein the setting up comprises setting, as the link for communication with the other station, a subchannel having a top priority among subchannels excluding a subchannel used for the frequency selective transmission.

8. The method of claim 1, wherein the scheduling information comprises period information of the frequency selective transmission performed by the access point.

9. The method of claim 1, wherein the setting up comprises:
determining at least one schedule about a subchannel to be used for communication with the other station based on period information of the frequency selective transmission; and
selecting a schedule to be used for communication with the other station from among the at least one schedule, through negotiation with the other station.

10. The method of claim 9, wherein the selecting comprises negotiating with the other station based on at least one of channel information, a power saving period of the station and a size of data to be transmitted by the station.

11. The method of claim 9, wherein the selecting comprises negotiating with the other station about a wakeup schedule.

12. The method of claim 8, wherein the period information of the frequency selective transmission is signaled in a form of a periodic restricted access window (PRAW).

13. A station, comprising:
a communicator configured to receive scheduling information on a frequency selective transmission from an access point; and
a link setter configured to set up a link for communication with another station based on the scheduling information,
wherein the communicator is configured to communicate with the other station using the link.

14. The station of claim 13, wherein the link setter is configured to determine a subchannel for communication with the other station from among at least one subchannel unused for the frequency selective transmission based on the scheduling information.

15. The station of claim 13, wherein the link setter is configured to set priorities of subchannels unused for the frequency selective transmission based on the scheduling information, and to determine a subchannel to be used for communication with the other station based on the set priorities.

16. The station of claim 13, wherein the link setter is configured to set, as the link for communication with the other station, a subchannel orthogonal to a subchannel used for the frequency selective transmission.

17. The station of claim 13, wherein the link setter is configured to determine at least one schedule about a subchannel to be used for communication with the other station based on period information of the frequency selective transmission received from the access point, and to select a schedule to be used for communication with the other station from among the at least one schedule, through negotiation with the other station.

18. The station of claim 14, wherein
the link setter is configured to store information on the determined subchannel in a channel switch request frame, and
the communicator is configured to transmit the channel switch request frame to the other station.

19. A station, comprising:
a link setter configured to request an access point for information on a frequency selective transmission or restricted access window parameter set (RPS) information using a probe request frame; and
a communicator configured to receive information on the frequency selective transmission or the RPS information from the access point in response to the request,
wherein the link setter is configured to set up a link for communication with another station based on information on the frequency selective transmission or the RPS information.

20. A method for direct communication between stations performed by a station, the method comprising:
receiving scheduling information on a frequency selective transmission from an access point;
determining a tunneled direct link setup (TDLS) schedule for communication with another station based on the scheduling information on the frequency selective transmission; and
performing a TDLS with the other station based on the determined TDLS schedule.
